(19) United States
(12) Patent Application Publication
(10) Pub. No.: US 2012/0251078 A1
(43) Pub. Date: Oct. 4, 2012

(54) Aggregated Facial Tracking in Video

(75) Inventors: Ido Leichter, Haifa (IL); Eyal Krupka, Shimshit (IL); Igor Abramovski, Haifa (IL); Igor Kviatkovsky, Haifa (IL)

(73) Assignee: MICROSOFT CORPORATION, Redmond, WA (US)

(21) Appl. No.: 13/076,445

(22) Filed: Mar. 31, 2011

(51) Int. Cl. H04N 5/93

(52) U.S. Cl. 386/278; 386/E05.028

(57) ABSTRACT

A facial detecting system may analyze a video by traversing the video forwards and backwards to create tracks of a person within the video. After separating the video into shots, the frames of each shot may be analyzed using a face detector algorithm to produce some analyzed information for each frame. A facial track may be generated by grouping the faces detected and by traversing the sequence of frames forwards and backwards. Facial tracks may be joined together within a shot to generate a single track for a person's face within the shot, even when the tracks are discontinuous.

### BACKGROUND

Face tracking in video can be difficult. Many face detector algorithms may detects a face when a person is facing a camera, but may be less accurate when the person is viewed in profile. As the person turns away from the camera, the face detector algorithms may fail to detect a face at all.

### SUMMARY

A facial detecting system may analyze a video by traversing the video forwards and backwards to create tracks of a person's face within the video. After separating the video into shots, the frames of each shot may be analyzed using a face detector algorithm to produce some analyzed information for each frame. A facial track may be generated by grouping the faces detected and by traversing the sequence of frames forwards and backwards. Facial tracks may be joined together within a shot to generate a single track for a person's face within the shot, even when the tracks are discontinuous.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a diagram of an embodiment showing a network environment with a device that analyzes video.

FIG. 2 is a flowchart of an embodiment showing a method for analyzing video.

FIG. 3 is a flowchart of an embodiment showing a method for determining shots in a video.

FIG. 4 is a flowchart of an embodiment showing a method for facial tracking in video.

FIG. 5 is a flowchart of an embodiment showing a method for linking analysis of existing facial tracks.

FIG. 6 is an example diagram of an embodiment showing a sequence of video frames with a resulting facial track.

### DETAILED DESCRIPTION

A facial detecting system may detect faces within a video by analyzing both forward and backward through a video's sequence of frames. The faces may be initially detected by a face detection algorithm on a frame by frame basis, and then processed using a facial track analyzer to create a sequence of frames containing the same face.

The facial track analyzer may operate by traversing the sequence of frames in a forward and/or backward manner to detecting matching faces. Once a set of sequences of faces are detected, a facial track may be generated by connecting the face objects from successive frames in the video. In many cases, multiple facial tracks may be generated in a video shot for a person's face because some frames may not have the face detected. In such cases, the separate facial tracks may be joined together into a single facial track by comparing the tracks in various manners.

The facial tracks may be generated by comparing merely the position and size of facial objects in some embodiments. In such embodiments, the trajectory of a facial object may be determined from two, three, or more frames and a new frame may be analyzed to determine if the new frame contains a face object that matches the trajectory.

In some embodiments, the facial tracks may be generated by comparing information derived from the image, such as color histograms, facial structure, or other data. In such embodiments, facial objects may be compared and found to be the same when the similarities between the facial objects are found to be within a predetermined threshold.

In many embodiments, facial detection may be performed on a frame by frame basis, where each frame may be analyzed using a face detection algorithm. In such embodiments, the frames may be analyzed as static, independent images. Such algorithms may not be very accurate and may incorrectly detect objects that are not faces or may not detect faces that were present. By analyzing the frame information by traversing both forward and backward through the sequence of frames to create a facial track, some of the noise or unreliability of the static face detection algorithms may be eliminated.

Throughout this specification, like reference numbers signify the same elements throughout the description of the figures.

When elements are referred to as being “connected” or “coupled,” the elements can be directly connected or coupled together or one or more intervening elements may also be present. In contrast, when elements are referred to as being “directly connected” or “directly coupled,” there are no intervening elements present.

The subject matter may be embodied as devices, systems, methods, and/or computer program products. Accordingly, some or all of the subject matter may be embodied in hardware and/or in software (including firmware, resident software, micro-code, state machines, gate arrays, etc.) Furthermore, the subject matter may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. By way of example, and not limitation, computer readable media may comprise computer storage media and communication media.

Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by an instruction execution system. Note that the computer-usable or computer-readable medium could be paper or another suitable medium upon which the program is printed, as the program can be electronically captured, via, for instance, optical scanning of the paper or other medium, then compiled, interpreted, of otherwise processed in a suitable manner, if necessary, and then stored in a computer memory.

Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

When the subject matter is embodied in the general context of computer-executable instructions, the embodiment may comprise program modules, executed by one or more systems, computers, or other devices. Generally, program modules include routines, programs, objects, components, data structures, etc. that perform particular tasks or implement particular abstract data types. Typically, the functionality of the program modules may be combined or distributed as desired in various embodiments.

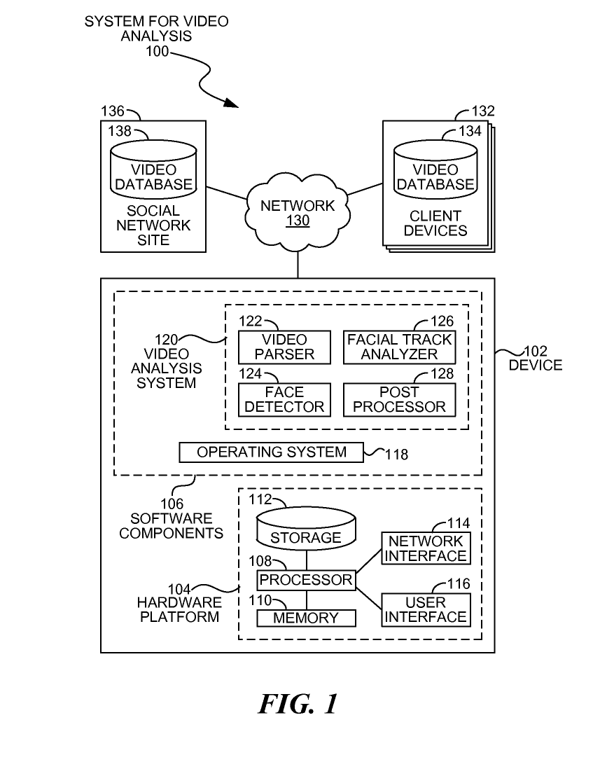

FIG. 1 is a diagram of an embodiment 100, showing a system for video analysis. Embodiment 100 is a simplified example of a device that may receive video, break the video into shots, and analyze each frame of each shot to detect a track for a face object across the video frames.

The diagram of FIG. 1 illustrates functional components of a system. In some cases, the component may be a hardware component, a software component, or a combination of hardware and software. Some of the components may be application level software, while other components may be operating system level components. In some cases, the connection of one component to another may be a close connection where two or more components are operating on a single hardware platform. In other cases, the connections may be made over network connections spanning long distances. Each embodiment may use different hardware, software, and interconnection architectures to achieve the described functions.

A system for facial tracking creates a facial track that may span multiple frames of a video shot. The system may use the results of a frame-by-frame facial detection algorithm, then create facial tracks that span multiple frames that may minimize missing or incorrect facial detections. The system may analyze a video shot both forwards and backwards to connect faces in a sequence of frames.

By examining the sequence of frames to connect faces, frames that may have a missing or unreliably detected face may be included into a facial track. Further, misinterpreted or incorrect facial detections may be ignored when those detections do not find nearby frames that also contain a matching face.

The system may have the effect of smoothing errors in a frame-by-frame facial detection system. Many facial detection algorithms may operate well when a person faces the camera directly. As the person turns their head to the side, a typical facial detection system may lose confidence that the object being analyzed is a face as the full facial features may be missing. For example, a person's picture from the profile may contain a single eye, a nose profile, and half of a mouth, which may be not be detected as a face with high reliability. A full, face-on view may contain two eyes, a nose, and a mouth, which may be much more reliably detected.

The analysis of faces in video may take advantage of the fact that video frames before and after a given frame may contain additional information that may assist in determining if indeed a face is present, as well as fill in when a face may not be properly detected.

A video analysis system may first break up a video into various shots. Each shot may be a sequence of frames that are similar and may contain the same faces. In some cases, a shot boundary may be determined when a camera operator begins and ends a specific video segment, creating individual shots. In other cases, the scene may change sufficiently that a new shot may be created even when the camera is still recording. Such an event may occur when a camera operator turns quickly and changes the view.

The shots may be analyzed to find a facial track within the shots. In many embodiments, a facial track may be determined by assuming that the position and size of a face may be consistent from one frame to another. Such an algorithm may not operate as intended across shot boundaries. Consequently, many video parsers may err on the side of creating too many shots from a video than too few. Too many shots may stem from a condition where a video parser is overly sensitive to a change in shots and may detect a shot boundary when one may not actually exist. Too few shots may occur when a video parser may be less sensitized and may not detect an actual shot boundary.

A face detector may analyze each frame of a video shot to detect faces within the frame. Many embodiments may operate a face detector by analyzing the frames separately and independently from other frames. The face detector may use any type of face detection mechanism to detect faces within the still image of a frame.

In many cases, a face detector may detect one or more faces and may provide a position and size for the face objects. Some embodiments may include a reliability factor for the detection, which may indicate a confidence that the algorithm may have in the detection. Some embodiments may include various characteristics about the face, such as facial structure analysis, color histograms, or other information derived from the image itself.

A facial track analyzer may attempt to connect facial objects from one frame to another by analyzing the sequence of frames in both forward and backward directions. In some embodiments, the facial track analyzer may attempt to match the facial objects in nearby frames by comparing just the position and size of the facial objects in nearby frames. Other embodiments may compare additional factors, such as factors derived from image analysis to match facial objects.

In some embodiments, a first pass for matching facial objects may be made using position and size of the facial objects. A second pass may be performed using image analysis factors to verify or supplement the initial findings made using the position and size analysis.

The facial track analyzer may create a first set of facial tracks, and then may attempt to join facial tracks within a shot. The process of joining facial tracks may join tracks that are discontinuous but may show the same face. The joining process may select non-overlapping facial tracks and join them using either or both of a position and size analysis or image factor analysis.

In some embodiments, the facial tracks may be compared to other facial tracks in other shots. In such embodiments, the facial tracks may be compared using image analysis, such as facial structure, color histograms, or other types of analysis to determine that two facial tracks are for the same person.

The system of embodiment 100 is illustrated as being contained in a single device 102. In many embodiments, various software components may be implemented on many different devices. In some cases, a single software component may be implemented on a cluster of computers. Some embodiments may operate using cloud computing technologies for one or more of the components.

The system of embodiment 100 may be accessed by various client devices 132. The client devices 132 may access the system through a web browser or other application. In one such embodiment, the device 102 may be implemented as a web service that may process video in a cloud based system. Such embodiments may operate by receiving video images from various clients, processing the video images in a large datacenter, and returning the analyzed results to the clients.

In another embodiment, the operations of device 102 may be performed by a personal computer, server computer, or other computing platform within the control of a user. Such an embodiment may be implemented with a software package that may be distributed and installed on a user's computer.

In still another embodiment, the operations of device 102 may be implemented in a video camera or other specialized device. When implemented in a video camera, the camera may shoot a video segment, and then perform an analysis on the video segment after the fact, for example.

The device 102 may have a hardware platform 104 and software components 106. The client device 102 may represent any type of device that may communicate with a video source, such as various client devices 132, social network sites 136, or other sources. In some cases, the client device 102 may have a video camera or other capture device that may generate video within the client device 102.

The hardware components 104 may represent a typical architecture of a computing device, such as a desktop or server computer. In some embodiments, the client device 102 may be a personal computer, game console, network appliance, interactive kiosk, or other device. The client device 102 may also be a portable device, such as a laptop computer, netbook computer, personal digital assistant, mobile telephone, or other mobile device.

The hardware components 104 may include a processor 108, random access memory 110, and nonvolatile storage 112. The processor 108 may be a single microprocessor, multi-core processor, or a group of processors. The random access memory 110 may store executable code as well as data that may be immediately accessible to the processor 108, while the nonvolatile storage 112 may store executable code and data in a persistent state.

The hardware components 104 may also include one or more user interface devices 114 and network interfaces 116. The user interface devices 114 may include monitors, displays, keyboards, pointing devices, and any other type of user interface device. In some embodiments, the user interface components may include a camera or other video capture device. The network interfaces 116 may include hardwired and wireless interfaces through which the device 102 may communicate with other devices.

The software components 106 may include an operating system 118 on which various applications may execute.

A video analysis system 120 may process video to detect facial tracks. A video parser 122 may analyze a video image to separate the video into shots. Each shot may be a sequence of frames that are related in space and time. The shot may contain the same scene and, when people are present, the people in scene may move smoothly and continuously.

A face detector 124 may analyze each frame of a shot to attempt to find faces in the frames. The face detector 124 may analyze each frame as a static image, and may or may not use adjacent frames to detect faces. The face detector 124 may return a set of information for each face. The set of information may vary from one embodiment to another. The set of information may include a position and size for each face, which may be a set of coordinates for the face and a rectangular or other shaped size for the face object. The set of coordinates may be a point in the center or a corner of the face object. In some embodiments, the size may be expressed in a height and width of a rectangle, a radius of a circle, a pair of radii for an ellipse, or some other indication of size.

In some embodiments, the set of information may include additional information that may be derived from the image itself. Such information may include a color histogram of the facial object, facial structural features, or some other information. Such information may be used to match facial objects by comparing similar image features.

A facial track analyzer 126 may use the output from the face detector 124 to create sequences of frames that contain the same facial object. Some embodiments may compare just the position and size of faces within a shot to link together facial objects in successive frames. Other embodiments may use information derived from the image to find matching face objects in successive frames.

In some embodiments, the facial track analyzer 124 may analyze the successive frames both forward and backward within the video sequence. The facial track analyzer 124 may compare a facial object in one frame to groups or clusters of frames in either direction from the given frame. In such embodiments, a clustering analysis or clustering algorithm may be used to identify matches.

Some embodiments may use an object tracking algorithm to track a facial object across multiple frames. Some object tracking algorithms may determine a possible trajectory for an object across the video frames to determine a track. The facial track analyzer 126 may analyze similar facial objects across multiple frames using various techniques, such as blob tracking, kernel based tracking, contour tracking, or other tracking mechanisms.

The facial track analyzer 126 may use metadata about the facial objects with an object tracking algorithm. Because a person's face may change characteristics within the video, such as when the person turns their head from being straight towards the camera, to a profile shot, to facing away from the camera, a conventional object tracking mechanism may not be as effective as the facial track analyzer 126 that may use the metadata about the facial objects created by the face detector 124.

The metadata may include a face object that may be detected from various facial orientations, which may be very different images. The facial track analyzer 126 may associate facial objects together and detect and verify those associations with various object tracking mechanisms.

A post processor 128 may attempt to join non-overlapping facial tracks into longer facial tracks. The post processor 128 may use position and size analysis to determine if two facial tracks may be related. In some embodiments, the post processor 128 may use image analysis comparisons, such as facial structure comparisons or color histogram analyses, to determine a match.

In some embodiments, the post processor 128 may attempt to match two facial tracks by finding the most reliably detected face object within a first facial track and compare that face object with a most reliably detected face object within a second facial track. The two reliable facial images may be the best facial representation of each facial track, and comparisons between those images may be more certain than the last image from one track and the first image of a second track.

The video analysis system 120 may be connected to other devices over a network 130. The network 130 may be a personal area network, local area network, wide area network, the Internet, or any other network.

Various client devices 132 may have video in various forms. The video databases 134 may be any type of repository that contains video that may be analyzed. The client devices 132 may be personal computers or other devices to which a user may have uploaded video from various video sources. The client devices 132 may be video cameras, cellular telephones, personal digital assistants, or other video capture devices.

In some embodiments, various social network sites 136 may contain a video database 138 that users may upload videos to share. The social network sites 136 may be configured to transfer video to the video analysis system 120 to have the video analyzed and detect persons in the video.

In many embodiments, the output of the video analysis system 120 may be used to attempt to identify actual persons in the video. The output may detect a facial track for a person, and an image matching system may attempt to associate an actual person's name or other information with the video's facial tracks. Such as system is not shown in the embodiment 100 and is merely one use scenario for the video analysis system 120.

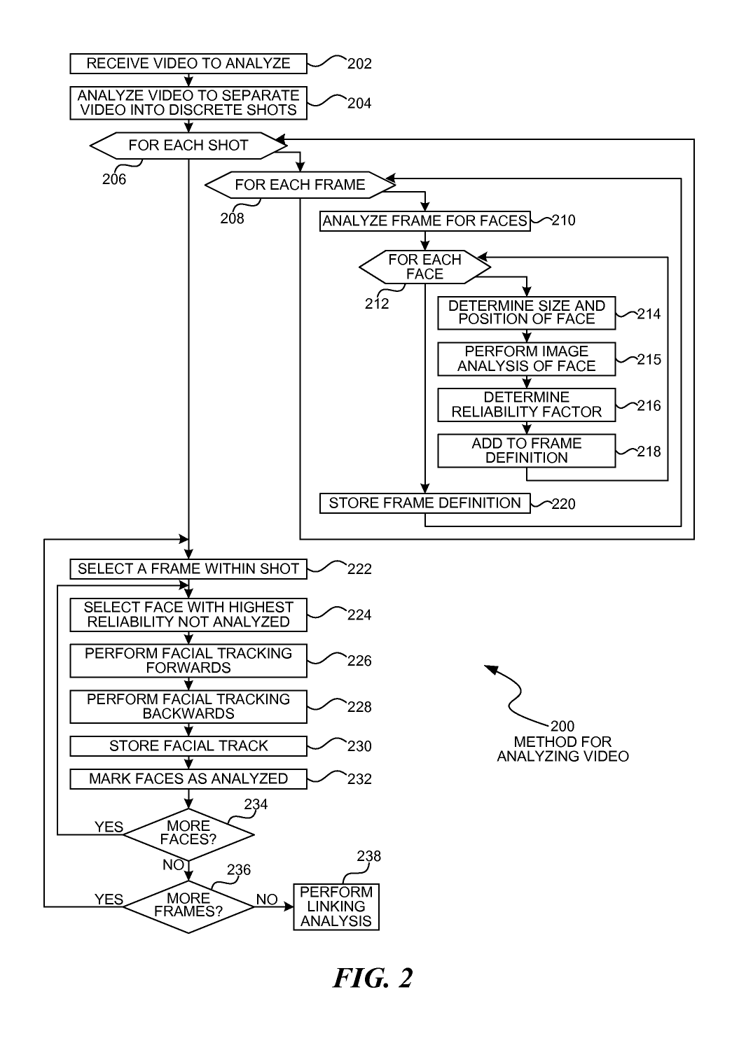

FIG. 2 is a flowchart illustration of an embodiment 200 showing a method for analyzing video. Embodiment 200 is a simplified example of a method that may be performed by a video analysis system 120 to parse a video into shots, perform a frame by frame static analysis of the video shot, and use the output of the static facial analysis to create a facial track that spans multiple frames of the video.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

Embodiment 200 illustrates one method by which video may analyzed to create tracks of faces through the video. After a video is broken into shots, each shot may be analyzed on a frame by frame basis for static facial detection. The frame by frame analysis results may then be used to link multiple frames together to show the movement or progression of a single face through the video.

In block 202, the video to analyze may be received. The video may be any type of video image that is made up of a series or sequence of individual frames. The video may be separated into discrete shots in block 204. Each shot may represent a single scene or set of related frames. An example of a process that may be performed in block 204 is found later in this specification at embodiment 300.

Each shot may be analyzed in block 206. For each shot in block 206 and for each frame of each shot in block 208, the frame may be analyzed for faces in block 210. The analysis of block 210 may be a static image analysis that may detect faces within the static image. For each face detected in block 212, the size and position of the face is determined in block 214, image analysis of the face may be performed in block 215, and a reliability factor for the analysis may be determined in block 216. All of the analysis results may be stored in a face definition in block 218.

The analysis of the faces may include a position and size definition. In some embodiments, the position and size may indicate a location within the frame for a particular face. The size may define the area of the image that contains the face. In many embodiments, the position may be the center point of the face boundary, but other embodiments may define a corner or other location. The size of the face may be indicated by a geometric shape, such as a rectangle, square, circle, ellipse, hexagon, octagon, or other shape. In some cases, the size may be defined in one, two, three, or more values. In a typical example of a rectangle shape, the size may be defined using height and width dimensions.

The image analysis of the face may include various data derived from the image itself, such as color histograms, facial structural variables, or other information. Some embodiments may use image analysis information to compare two face objects to determine if the objects are a match. Such matching may be performed to associate two sequential frames, two separate facial tracks, or for other matches, depending on the embodiment.

The reliability factor of block 216 may be a statistical or other indicator for the confidence in the analysis. The reliability factor may indicate the confidence the facial detection algorithm may have that the object is indeed a face. Facial detection can be a complex algorithm with a large amount of variability. Each algorithm may have different mechanisms for indicating reliability, such as a numerical score from 0 to 1 or 1 to 10, a qualitative indicator such as high, medium, low, or some other indicator.

After analyzing each face in the frame and storing the facial objects in block 218, the analyzed frame definition may be stored in block 220. The process of blocks 206 through 220 may be repeated for each frame of each shot.

A frame within a shot may be selected in block 220. In some embodiments, the frame of block 220 may be any frame within the shot. Some embodiments may scan the frames within a shot to find the most reliably detected face object within the shot. From that frame, the most reliably detected face object that has not been analyzed may be selected in block 224.

Using the selected face object, facial tracking may be performed forwards in block 226 through the video sequence and backwards in block 228 in the video sequence. An example embodiment of the process of blocks 226 and 228 may be found later in this specification in embodiment 400.

The results of the facial tracking analyses may be stored in block 230 and the face objects may be marked as processed in block 232. If there are more faces in the current frame in block 234, the process may return to block 224 to select another face. If there are more frames in the shot that have not been analyzed in block 236, the process may return to block 222 to select another frame.

Once the frames have been analyzed in block 236, linking analysis may be performed in block 238. An example of a linking analysis may be found later in this specification in embodiment 500.

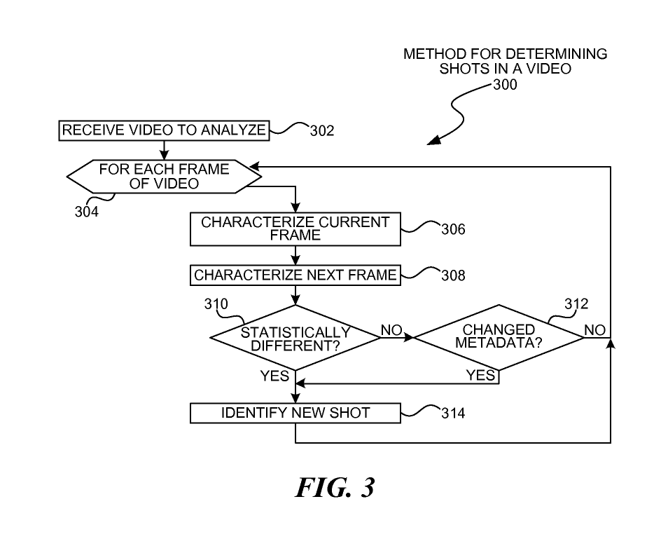

FIG. 3 is a flowchart illustration of an embodiment 300 showing a method for determining shots within a video. Embodiment 300 is a simplified example of a method that may be performed by a video parser, such as the video parser 122 of embodiment 100.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

The method of embodiment 300 illustrates one example of how to separate a video sequence into discrete shots. Each shot may be a sequence of frames that are similar and may have the same facial images in a facial track.

The video to analyze may be received in block 302. For each frame in the video in block 304, the current frame may be characterized in block 306 as well as the next frame in block 308. The characterizations of the frames may be compared in block 310 to determine if the frames are statistically different. If the blocks are not significantly different in block 310, the metadata associated with the frames in block 312 may be compared to determine if the shots may have changed. If not, the process may return to block 304 to process the next frame.

If the statistical analysis or metadata analysis indicates that the shot has changed in either block 310 or 312, a new shot may be identified in block 314. The process may return to block 304 to process another frame. The process of embodiment 300 may continue until each frame of the video is processed.

The statistical comparison of block 310 may compare various statistics or information derived from the images of the frame. Such information may include color histograms, object analysis, or other analyses of the image. When the images change abruptly from one frame to another, a new shot may be indicated.

The metadata analysis of block 312 may include examining time stamps or other metadata associated with each frame. When the timestamps change significantly from one frame to another, the timestamps may indicate that the camera operator stopped and restarted the camera, indicating a new shot.

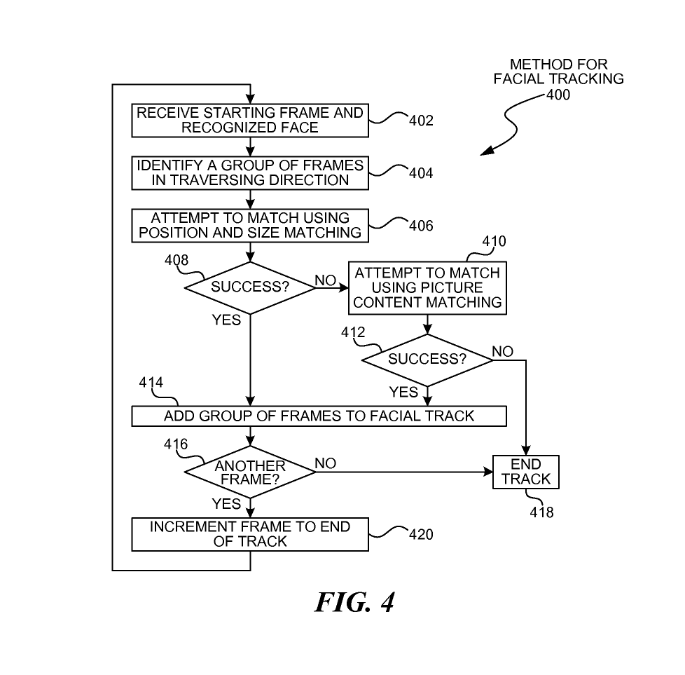

FIG. 4 is a flowchart illustration of an embodiment 400 showing a method for facial tracking within a video shot. Embodiment 400 is a simplified example of a method that may be performed by a facial track analyzer, such as facial track analyzer 126 of embodiment 100.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

Embodiment 400 illustrates one method by which a facial track may be created. A facial track may be a sequence of facial objects that are linked together in a sequence of frames of a video. The facial track may represent the same facial object as it moves and changes through a video shot.

In block 402, the starting frame and a detected face object may be received. A group of frames in the traversing direction may be identified in block 404. The traversing direction may be forwards or backwards through the video stream and may use frames preceding and subsequent to a starting frame.

In some embodiments, the starting frame may be selected by scanning the frames within a shot and selecting the most reliably detected face object. A facial track may be created using the most reliably detected face object, then each subsequent facial track may be created using the same method of selecting the most reliably detected face object that has not already been placed into a facial track.

The face object in the current frame may be compared to the face objects in the group of frames in block 406 using trajectory analysis. Trajectory analysis may attempt to match the face objects based on the position and size of the face objects. In many embodiments, such an analysis may use only position and size comparisons and may or may not use information derived from the image analysis.

If there is a successful match in block 408, the group of frames may be added to the facial track in block 414.

If there is not a successful match in block 408, a match may be attempted using image analysis results in block 410. The image analysis results may use color histograms, facial structure analysis, or other types of comparisons using information derived from the images associated with the face objects. If there is a successful match in block 412, the process may continue to block 414 and the group of frames may be added in block 414. If there is not a successful match in block 412, the track may be ended in block 418.

When a successful match is found in blocks 408 or 412 and the frames are added to the facial track in block 414, if there are additional frames in the shot in block 416, the current frame may be incremented in block 420 and the process may return to block 402 to be repeated. If there are no additional frames in block 416, the track may be ended in block 418.

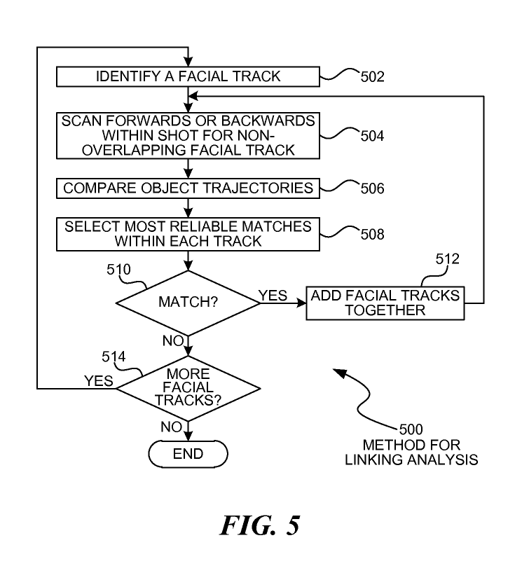

FIG. 5 is a flowchart illustration of an embodiment 500 showing a method for linking facial tracks. Embodiment 500 is a simplified example of a method that may be performed by a post processor, such as the post processor 128 of embodiment 100.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

Embodiment 500 illustrates one method by which facial tracks may be linked together to form a longer facial track through a shot. The linking analysis of embodiment 500 may attempt to join facial tracks from the same face object into a single, long facial track.

Part of the operations of embodiment 500 analyzes non-overlapping facial tracks, where non-overlapping facial tracks are those that do not share a common frame. Overlapping facial tracks within a shot may indicate that two separate faces are shown in the same frame. Because the overlapping facial tracks indicate two separate faces, considering joining such facial tracks would be improper.

A facial track may be detected in block 502. Within the shot, non-overlapping facial tracks may be detected in both forward and backward directions from the given facial track in block 504. The detected facial tracks may be those which are potential matches with the given facial track.

The object trajectories of the potentially matching facial tracks may be compared in block 506. The object trajectories may use the position and size of the facial objects to compare the facial tracks. In some embodiments, merely the position of the face objects may be compared, while other embodiments may use both position and size in the trajectory analysis.

Within each facial track, the most reliably detected face objects may be selected in block 508 and compared in block 510. The comparison in block 510 may use image analysis results to determine whether or not the facial tracks represent the same face. If there is a match in block 510, the facial tracks may be added together in block 512. If there is not a match in block 510, and there are more facial tracks within the shot in block 514, the process may return to block 502 to process another facial track. If no more facial tracks are available in block 514, the process may end in block 516.

In some embodiments, the process of embodiment 500 may be used to link facial tracks from different shots. In such a case, the embodiment 500 may be used without comparing the object trajectories of block 506. Such an embodiment may select a face object from the two potentially matching facial tracks and use image analysis results to determine if the facial tracks are a match. If so, the facial tracks may be joined across the shot boundary.

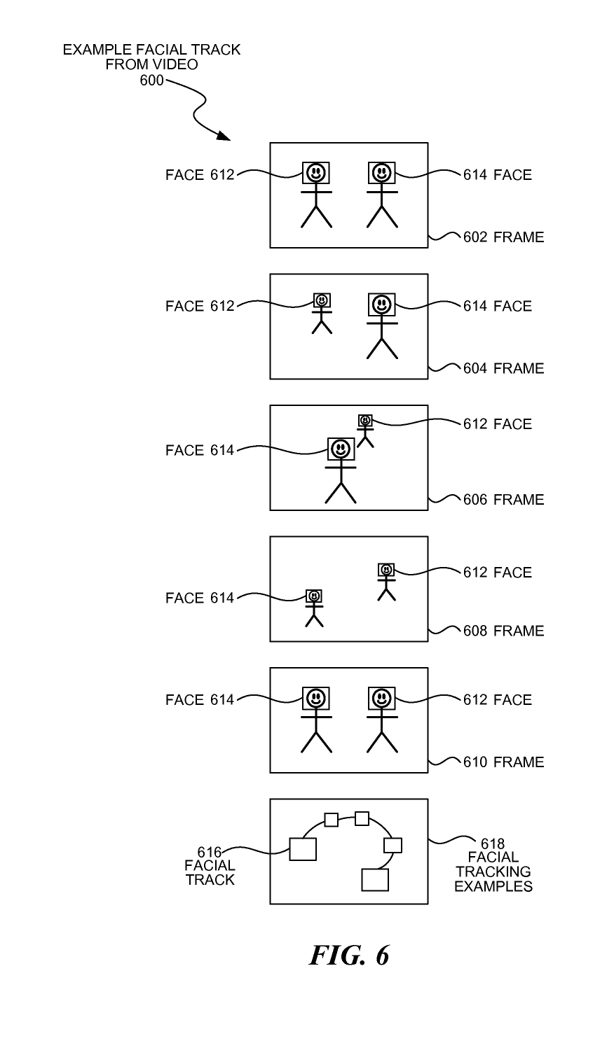

FIG. 6 is a diagram illustration of an example embodiment 600 showing a facial track from a single shot. Embodiment 600 illustrates five frames that show two faces and an illustration of one of the facial tracks derived from the sequence of frames. Embodiment 600 is a very simplified example for illustration purposes.

Frames 602, 604, 606, 608, and 610 illustrate successive frames of a single video shot. Within each frame are faces 612 and 614, each of which traverse the frames in sequence. Face 612 moves to the background and to the left in the sequence, while face 614 moves to the front and to the right in the sequence.

After traversing the frames, a facial track 616 may be generated that links the various position and sizes of face 612 across the frames. Facial track 616 may illustrate the face object as it moves through the successive frames.

The foregoing description of the subject matter has been presented for purposes of illustration and description. It is not intended to be exhaustive or to limit the subject matter to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments except insofar as limited by the prior art.

What is claimed is:

1. A method performed on at least one computer processor, said method comprising:
receiving a video comprising a sequence of frames;
for at least one shot in said video, analyzing each of said frames to detect faces, said faces being identified with at least a position and a size;
creating a first facial track by:
selecting a first face in a first frame;
analyzing at least one frame subsequent said first frame to identify said first face; and
analyzing at least one frame preceding said first frame to identify said first face to create said first facial track.

2. The method of claim 1 said creating at least one facial track further comprising:
identifying a second facial track;
determining that said first facial track contains a similar face as said second facial track; and
combining said first facial track and said second facial track into a single facial track.

3. The method of claim 2, said second facial track not sharing a common frame with said first facial track in said sequence of said frames.

4. The method of claim 3, said determining that said first facial track contains a similar face as said second facial track being performed using image analysis of at least one face in said first facial track and at least one face said second facial track.

5. The method of claim 4, said image analysis comprising color histogram analysis.

6. The method of claim 4, said image analysis comprising facial structure analysis.

7. The method of claim 1, said first face being identified by comparing said position and said size from said first face in a first frame to said position and said size from said first face in said second frame.

8. The method of claim 7, said first face being identified by comparing said position and said size from said first face in a first frame to said position and said size from said first face in a group of frames comprising said second frame.

9. The method of claim 8, said comparing using a clustering algorithm.

10. A system comprising:
a face detector that:
analyzes each frame of a first shot in said video to identify faces, said faces being identified with at least a position and a size;
a facial track analyzer that:
selects a first face in a first frame;
analyzes at least one frame after said first frame to identify said first face; and
analyzes at least one frame before said first frame to identify said first face to create said first facial track;
said system being executed on at least one processor.

11. The system of claim 10, said facial track analyzer that:
combines a second facial track to said first facial track, said first facial track and second facial track not overlapping.

12. The system of claim 11, said facial track analyzer that:
combines said second facial track to said first facial, a first facial track being in a first shot and said second facial track being in a second shot.

13. The system of claim 10, said face detector identifying a reliability factor for said first face.

14. The system of claim 13, said facial track analyzer that further:
analyzes said facial track to determine a second frame comprising said first face and having a high reliability factor; and
selecting at least a portion of said second frame to represent said first face in said facial track.

15. The system of claim 10, said face detector that further:
generates image content analysis of said faces.

16. The system of claim 10, further comprising:
a video parser that:
receives a video comprising a sequence of frames; and
analyzing said video to identify at least one shot, said shot being a continuous sequence of said frames;

17. The system of claim 10, said facial track analyzer that analyzes said first face in said frame and said at least one frame before said first frame using said position and said size only.

18. A method performed on at least one computer processor, said method comprising:
receiving a video comprising a sequence of frames;
analyzing said video to identify at least one shot, said shot being a continuous sequence of said frames;
for a first shot, analyzing each of said frames to detect faces, said faces being identified with a position, a size, and a reliability factor;
creating a first facial track by:
selecting a first frame;
selecting a first face in said first frame, said first face having a high reliability factor for a plurality of faces in said first frame;
analyzing a first set of frames subsequent said first frame to identify said first face, said first face being found in at least one of said first set of frames; and
analyzing a second set of frames preceding said first frame to identify said first face to create said first facial track, said first facial track comprising all of said first set of frames and all of said second set of frames.

19. The method of claim 18, said first face being not found in at least one of said first set of frames.

20. The method of claim 19, said analyzing being performed only using said position and said size.
